(19) United States
(12) Patent Application Publication
(10) Pub. No.: US 2014/0026476 A1
(43) Pub. Date: Jan. 30, 2014

(54) Flat Surface Lawn and Garden Barrier

(71) Applicant: John David Murphy, Sydney (CA)

(72) Inventor: John David Murphy, Sydney (CA)

(21) Appl. No.: 13/944,261

(22) Filed: Jul. 17, 2013

Related U.S. Application Data
(60) Provisional application No. 61/676,386, filed on Jul. 27, 2012.

(51) Int. Cl. A01G 1/08

(52) U.S. Cl. CPC A01G 1/08
USPC 47/33

(57) ABSTRACT

A landscaping device is disclosed that provides users with an easily assembled decorative lawn or landscaping barrier. The landscaping device comprises a plurality of elongated members secured together in various configurations. The elongated members comprise a center portion, a first end portion, and a second end portion, with each end portion extending from the center portion. Furthermore, the first end portion of one elongated member is attachable to the second end portion of a second elongated member and can be secured via a stake. Specifically, the first end portion comprises an overlapping segment, and the second end portion comprises an opposing overlapping segment which mates with the overlapping segment of the first end portion to secure the elongated members together. A stake is then driven into the end portions to secure the elongated members to the surface. Once secure, the elongated members are substantially flush with each other.

### CROSS-REFERENCE

This application claims priority from Provisional Patent Application Ser. No. 61/676,386 filed Jul. 27, 2012.

### BACKGROUND

Traditional lawn or landscaping barriers available on the market today are typically built up from the ground, which makes it impossible for lawn mowers to pass over them. This can make it a hassle for individuals to cleanly landscape around the barriers, making even simple projects time consuming. Similar lawn or landscaping barriers may also require extensive digging to secure the barriers in place, which can damage the yard and be exhausting and time-consuming to install. These lawn or landscaping barriers may even require expensive professional help to properly install the same. Thus, a lawn or landscaping barrier that is cost effective, relatively easy to install and maintain and that does not unduly damage the yard is necessary.

The present invention provides an easily assembled decorative lawn or landscaping barrier device. The landscaping device comprises a plurality of decorative flat components (or elongated members) that fit together to form a barrier between lawns and gardens or walkways. The device can also be used along a structural foundation to help keep grass away from the foundation. The unique structure of the device features a low profile to allow lawn mowers to conveniently mow over the decorative flat components without causing damage to them or the mower. The decorative flat components are set flat on the ground and can be assembled in different configurations then spiked into the ground to secure them in place without any digging or ground cutting. Anyone can easily assemble the decorative flat components in whatever customizable design they wish, making the landscaping device ideal for homeowners, businesses, public parks, or any other outdoor landscape.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a landscaping device that provides users with an easily assembled decorative lawn or landscaping barrier. The landscaping device comprises a plurality of elongated members secured together in various configurations. The elongated members comprise a center portion having opposing sides, a first end portion, and a second end portion, with each end portion extending from the center portion. Typically, the elongated members can be any suitable shape or size depending on the user's need and/or preference.

Furthermore, the first end portion of one elongated member is attachable to the second end portion of a second elongated member. Specifically, the first end portion comprises an overlapping segment, and the second end portion comprises an opposing overlapping segment which mates with the overlapping segment of the first end portion to secure the first and second elongated members together. Additionally, the first end portion and the second end portion of both the first and second elongated members comprise at least one through-hole for receiving a stake or other securing pin. In attaching the first and second elongated members, the first end portion of the first elongated member is positioned over top of the second end portion of the second elongated member such that the through-holes align. Once aligned, a stake is inserted through the overlapping through-holes securing the first and second elongated members together. The stake is then driven into the ground (or other surface) to secure the first and second elongated members in the ground.

In a preferred embodiment, the first and second elongated members once attached and secured to the ground, are substantially flush with each other, and the bottoms of the elongated members are substantially flush with the surface of the ground. Specifically, the first and second elongated members create a low profile to allow lawn mowers and other lawn care equipment to run over the elongated members without damage to them or the mower. Additionally, the bottom side of the elongated members is concave with respect to the surface on which the elongated members are secured. Thus, when the elongated members are positioned on the surface, the concave shape of the bottom side of the elongated members ensures that the edges of the elongated members press down securely against the surface when secured in place, allowing the bottoms of the elongated members to be relatively flush with the surface.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the landscaping device in accordance with the disclosed architecture.

FIG. 2 illustrates a top view of different sized elongated members of the landscaping device in accordance with the disclosed architecture.

FIGS. 3A-D illustrates a top view of the elongated members of the landscaping device put together in various configurations in accordance with the disclosed architecture.

FIG. 4 illustrates a perspective view of the landscaping device secured to the ground such that a lawn mower can pass over the elongated members in accordance with the disclosed architecture.

FIG. 5 illustrates a perspective view of the landscaping device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention provides an easily assembled decorative lawn or landscaping barrier device. The landscaping device comprises a plurality of interconnecting decorative flat components (or elongated members) that fit together end to end to form a barrier between lawns and gardens or walkways. The interconnecting decorative flat components can be different sizes and shapes, such as straight pieces or curved sections, corners, etc. The device can also be used along a structural foundation to help keep grass away from the foundation. The unique structure of the device features a low profile to allow lawn mowers to conveniently run over the decorative flat components without damage to them or the mower. The decorative flat components are set relatively flat on the ground and can be assembled in different configurations then spiked into the ground to secure the individual components together and to the ground without any digging or ground cutting. Anyone can easily assembly the decorative flat components in whatever customizable design they wish, making the landscaping device ideal for homeowners, businesses, public parks, or any other outdoor landscape.

The disclosed landscaping device comprises a plurality of elongated members secured together in various configurations. The elongated members comprise a center portion, a first end portion, and a second end portion, with each end portion extending from the center portion. Furthermore, the first end portion of one elongated member is attachable to the second end portion of a second elongated member and can be secured via a stake. Specifically, the first end portion comprises an overlapping segment, and the second end portion comprises an opposing overlapping segment which mates with the overlapping segment of the first end portion to secure the elongated members together. A stake is then driven into the end portions to secure the elongated members to each other and to the surface of the ground. Once secure, the elongated members are substantially flush with each other.

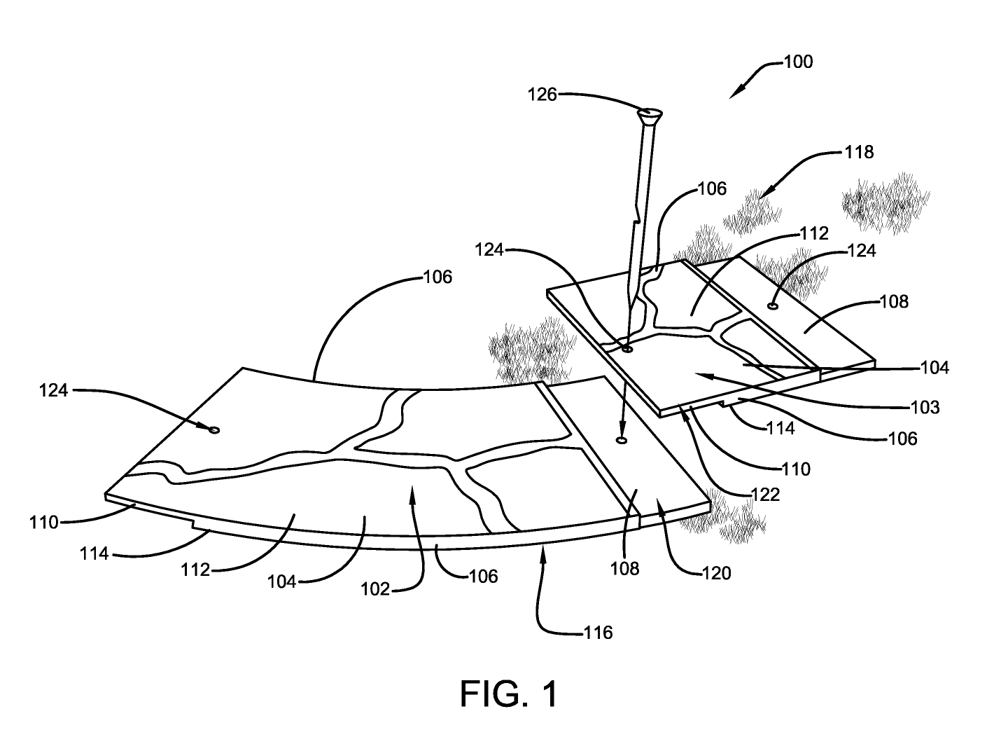

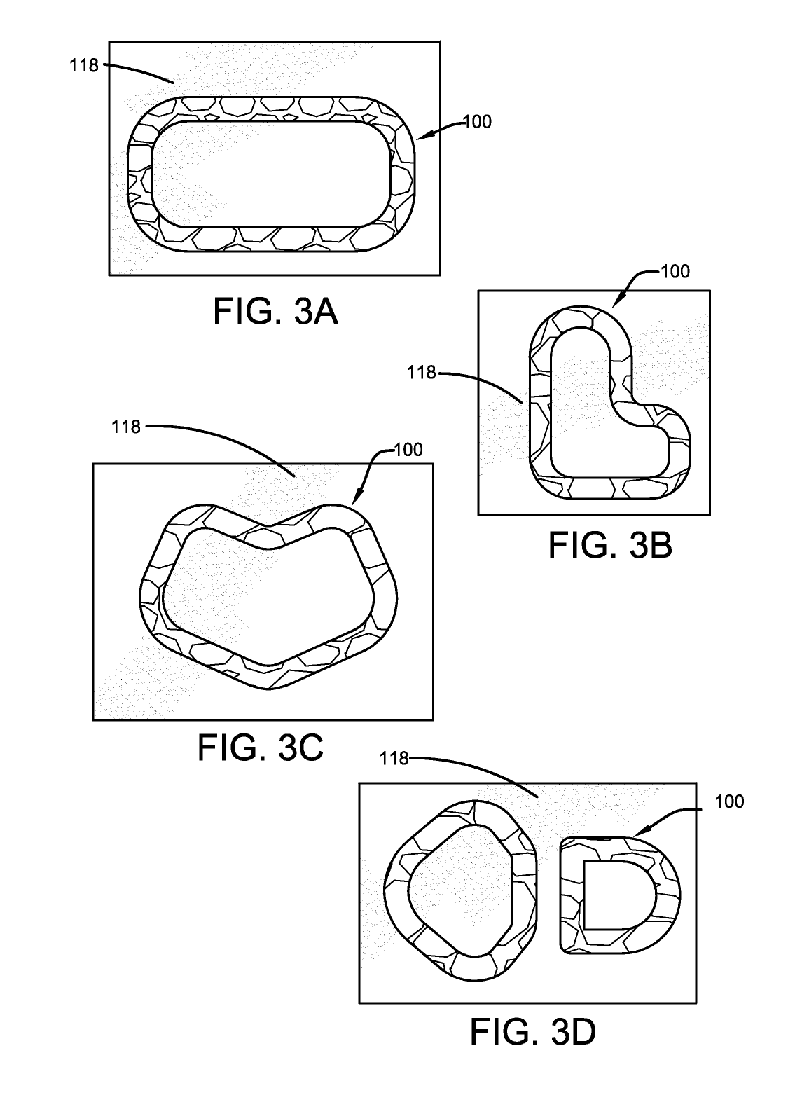

Referring initially to the drawings, FIGS. 1-2, 3A-D, and 4 illustrate the landscaping device 100 that provides users with an easily assembled decorative lawn or landscaping barrier. The landscaping device 100 comprises a plurality of elongated members 102 secured together in various configurations (as shown in FIGS. 3A-D).

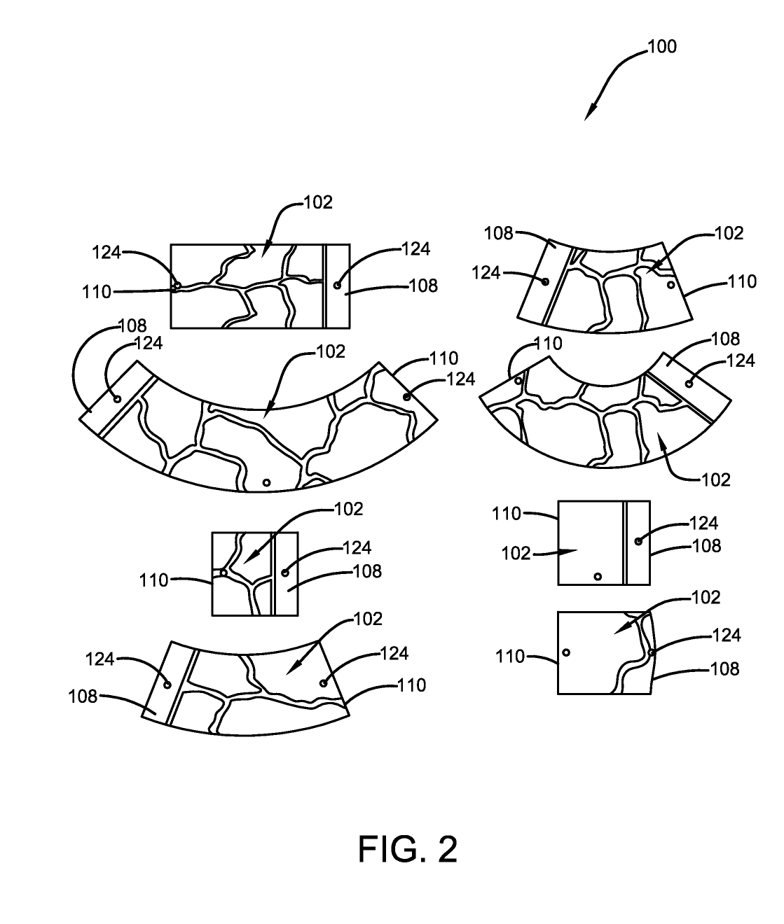

The elongated members 102 comprise a center portion 104 having opposing sides 106, a first end portion 108, and a second end portion 110, with each end portion (108 and 110) extending from the center portion 104. Typically, the elongated members 102 can be any suitable shape as is known in the art without affecting the overall concept of the invention, such as rectangular, square, arc-shaped, or even corner pieces, etc. (as shown in FIG. 2). The elongated members 102 would generally be constructed of homogeneous plastics, such as polyvinyl chloride (PVC), acrylonitrile butadiene styrene (ABS), polycarbonate (PC), etc., composite polymers, or recycled material, though any other suitable material may be used to manufacture the elongated members 102 as is known in the art without affecting the overall concept of the invention, as long as the material is generally weather resistant.

The elongated members 102 can also comprise a variety of colors and designs to suit user and manufacturing preference. While the shape and size of the elongated members 102 may vary greatly depending on the wants and needs of a user, the elongated members 102 are approximately between 4 and 100 inches long as measured from the first end portion 108 to the second end portion 110, and approximately between 4 and 30 inches wide as measured from opposing sides 106, and approximately between 0.12 and 1.0 inches thick as measured from a front surface 112 to a back surface 114.

Typically, the back surface 114 (or bottom side) of the elongated members 102 is concave (or curved generally inward) with respect to a surface 118 (i.e., ground, grass, mulch, dirt, gravel, etc.) on which the elongated members 102 are secured. Thus, when the elongated members 102 are positioned on the surface 118, the concave shape of the bottom side of the elongated members 102 ensures that the edges 116 of the elongated members 102 press down securely against the surface 118 when secured in place (as shown in FIG. 1).

Furthermore, the first end portion 108 of one elongated member 102 is attachable to the second end portion 110 of a second elongated member 103. Additionally, the first end portion 108 and the second end portion 110 are sized such that, when attached, the combined thickness of the first end portion 108 and the second end portion 110 are substantially the same as a thickness of the center portion 104 to create a generally level top surface of the attached elongated members 102 and 103.

Additionally, the first end portion 108 of the first and second elongated members 102 and 103 comprises an underlying portion (or segment) 120 or overlapping portion (or segment). Further, the second end portion 110 of the first and second elongated members 102 and 103 comprises an opposing overlapping portion (or segment) 122 or an underlying portion (or segment) which mates with the overlapping (or underlying) segment 120 of the first end portion 108. The overlapping (or underlying) segment 120 and the opposing overlapping (or underlying) segment 122 mate and are attached together via the overlapping segment 120 being placed on top of the opposing overlapping segment 122 or vice versa (i.e., being placed under the opposing overlapping segment 122).

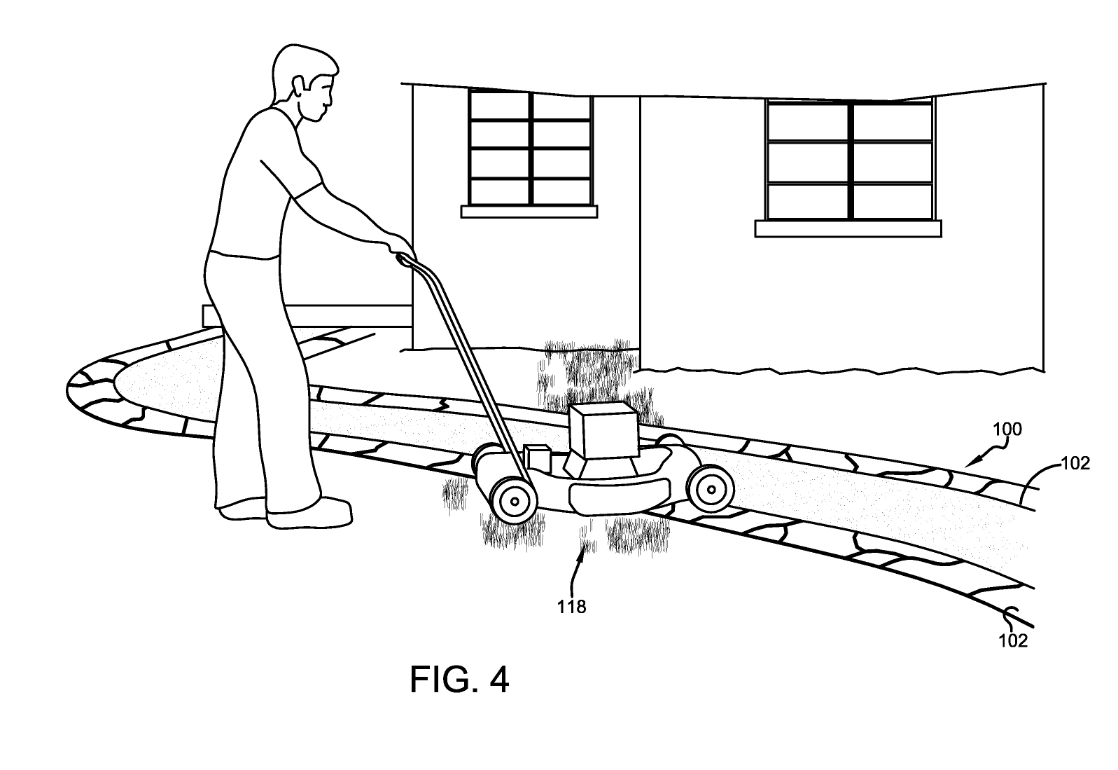

Furthermore, the first end portion 108 and the second end portion 110 of both the first and second elongated members (102 and 103) comprise at least one through-hole 124, or any other suitable opening as is known in the art for receiving a stake or other securing pin. In attaching the first and second elongated members (102 and 103), the first end portion 108 of the first elongated member 102 is positioned under the second end portion 110 of the second elongated member 103 (or vice versa) such that the at least one through-holes 124 substantially align. Once aligned, at least one stake 126, or any other suitable securing pin as is known in the art, can be inserted through the overlapping through-holes 124 of the first and second end portions (108 and 110), securing the first and second elongated members (102 and 103) together. The stake 126 is then driven into the ground (or other surface 118) to secure the first and second elongated member (102 and 103) in the ground. The first and second elongated members (102 and 103) once attached and secured to a surface 118, are substantially flush with each other. Specifically, the first and second elongated members (102 and 103), along with the stake 126, create a low profile to allow lawn mowers and other lawn care equipment to run over the elongated members (102 and 103) without damage to them or the mower (as shown in FIG. 4).

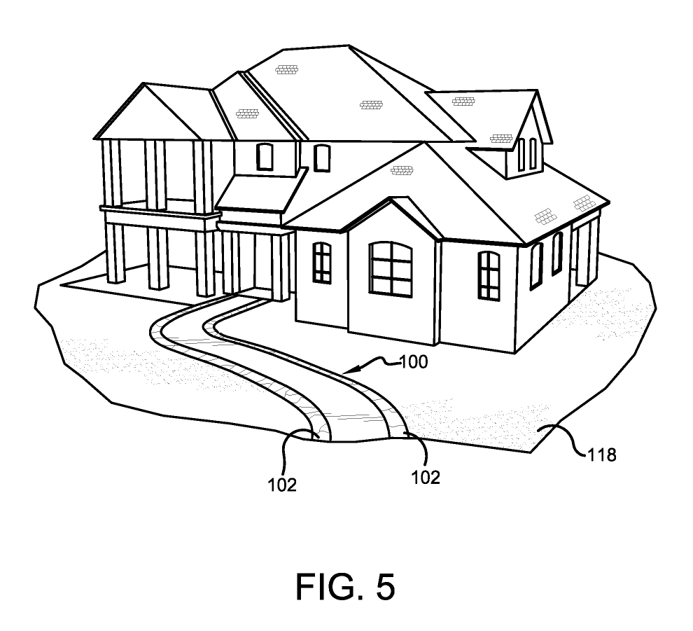

FIG. 5 illustrates the landscaping device 100 in use. In operation, a user (not shown) would choose the size, shape, and/or design of the landscaping device 100 that meets their needs and/or wants. The user would then determine where and in what configuration to position the landscaping device 100 in their yard and/or landscaping. The user would then position the interlocking elongated members 102 of the landscaping device 100 on the pre-determined surface 118 in the pre-determined configuration.

Specifically, the user would position the plurality of interlocking elongated members 102 on the surface 118 such that a first end portion 108 of one elongated member 102 (mates) or attaches to a second end portion 110 of a second elongated member 103 via placing a first end portion 108 under the second end portion 110 or vice versa. The user would then align the through-holes 124 of the first and second end portions (108 and 110).

Once aligned, the user would insert a stake 126 or other securing pin through the through-holes 124 and into the ground (or surface 118), securing the elongated members (102 and 103) together and securing the elongated members (102 and 103) to the ground (or surface 118). Once attached together and secured to the surface 118 (or ground), the plurality of interlocking elongated members 102 and the stake 126 are substantially flush with each other, such that lawn mowers and other lawn care equipment can run over the elongated members (102 and 103) without damage to them or the mower. Thus, users can easily assemble the plurality of elongated members 102 in whatever customizable design they wish for any outdoor or indoor surface or landscape.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A landscaping device comprising:
a first elongated member comprising a center portion having opposing sides, a first end portion, and a second end portion, each end portion extending from the center portion;
a second elongated member comprising a center portion having opposing sides, a first end portion, and a second end portion, each end portion extending from the center portion; and
wherein the first end portion of the first elongated member is attachable to the second end portion of the second elongated member, and the first end portion and the second end portion being sized such that, when attached, the combined thickness of the first end portion and the second end portion are substantially the same as a thickness of the center portion.

2. The landscaping device of claim 1, wherein each of the first end portion and the second end portion of both the first and second elongated members comprise at least one opening.

3. The landscaping device of claim 2, wherein the first end portion of the first elongated member is positioned over top of the second end portion of the second elongated member such that the at least one openings align.

4. The landscaping device of claim 3, wherein at least one stake can be inserted through the overlapping at least one openings of the first and second end portions, securing the first and second elongated members together.

5. The landscaping device of claim 1, wherein the first end portion of the first and second elongated members comprises an overlapping segment.

6. The landscaping device of claim 5, wherein the second end portion of the first and second elongated members comprises an opposing overlapping segment which mates with the overlapping segment of the first end portion.

7. The landscaping device of claim 1, wherein a plurality of elongated members are secured together to form a distinct configuration.

8. The landscaping device of claim 1, wherein a bottom side of the first and second elongated members is concave with respect to a surface on which the first and second elongated members are secured.

9. The landscaping device of claim 1, wherein the first and second elongated members are manufactured of homogeneous plastic, composite polymer, or recycled material.

10. The landscaping device of claim 1, wherein the first and second elongated members once attached and secured to a surface are substantially flush with each other.

11. A landscaping device comprising:
a first elongated member comprising a center portion having opposing sides, a first end portion, and a second end portion, each end portion extending from the center portion;
a second elongated member comprising a center portion having opposing sides, a first end portion, and a second end portion, each end portion extending from the center portion; and
wherein the first end portion of the first and second elongated members comprises an overlapping segment, and the second end portion of the first and second elongated members comprises an opposing overlapping segment which mates with the overlapping segment of the first end portion, such that the first end portion of the first elongated member is attachable to the second end portion of the second elongate member; and
wherein the first end portion and the second end portion being sized such that, when attached, the combined thickness of the first end portion and the second end portion are substantially the same thickness of the center portion.

12. The landscaping device of claim 11, wherein a plurality of elongated members are secured together to form a distinct configuration.

13. The landscaping device of claim 11, wherein a bottom side of the first and second elongated members is concave with respect to a surface on which the first and second elongated members are secured.

14. The landscaping device of claim 11, wherein each of the first end portion and the second end portion of both the first and second elongated members comprise at least one through-hole.

15. The landscaping device of claim 14, wherein the first end portion of the first elongated member is positioned over top of the second end portion of the second elongated member such that the at least one through-holes align.

16. The landscaping device of claim 15, wherein at least one stake can be inserted through the overlapping at least one through-holes of the first and second end portions, securing the first and second elongated members together.

17. The landscaping device of claim 11, wherein the first and second elongated members once attached and secured to a surface are substantially flush with each other.

18. The landscaping device of claim 11, wherein the first and second elongated members are manufactured of homogeneous plastic, composite polymer, or recycled material.

19. The landscaping device of claim 11, wherein the width of the first and second elongated members is approximately between 4 and 30 inches wide.

20. A landscaping device comprising:
a first elongated member comprising a center portion having opposing sides, a first end portion, and a second end portion, each end portion extending from the center portion;
a second elongated member comprising a center portion having opposing sides, a first end portion, and a second end portion, each end portion extending from the center portion; and
wherein the first end portion of the first and second elongated members comprises an overlapping segment, and the second end portion of the first and second elongated members comprises an opposing overlapping segment which mates with the overlapping segment of the first end portion, such that the first end portion of the first elongated member is attachable to the second end portion of the second elongate member;
wherein each of the first end portion and the second end portion of both the first and second elongated members comprise at least one through-hole, and at least one stake can be inserted through the overlapping at least one through-holes of the first and second end portions, securing the first and second elongated members together; and
wherein the first end portion and the second end portion being sized such that, when attached, the combined thickness of the first end portion and the second end portion are substantially the same thickness of the center portion, and are substantially flush with each other.
